(19) United States
(12) Patent Application Publication
(10) Pub. No.: US 2023/0046378 A1
(43) Pub. Date: Feb. 16, 2023

(54) RETAINING FRAME FOR A PLUG CONNECTOR, METHOD, PLUG CONNECTOR AND ELECTRONIC DEVICE

(71) Applicant: Phoenix Contact GmbH & Co. KG, Blomberg (DE)

(72) Inventor: Lukas Brillo, Hoexter (DE)

(21) Appl. No.: 17/793,941

(22) PCT Filed: Jan. 27, 2021
(86) PCT No.: PCT/EP2021/051799

§ 371 Date: Jul. 20, 2022

(30) Foreign Application Priority Data
Jan. 29, 2020 (DE) 10 2020 102 098.8

(51) Int. Cl. H01R 13/508; H01R 13/74

(52) U.S. Cl. CPC H01R 13/508; H01R 13/748

(57) ABSTRACT

A retaining frame for a plug connector for receiving contact inserts includes: a base frame having two opposing side walls and two opposing end walls, the two side walls and the two end walls enclosing an interior space of the base frame into which the contact inserts are introducible along an insertion direction, the side walls having a respective inner surface facing in a direction of the interior space and a respective outer surface directed away from the interior space; and securing means which, in a secured state, retain the contact inserts introduced into the interior space of the base frame on the base frame, the securing means respectively having a bracket element and an actuation lever, the bracket element being transferrable into a closed position in which the bracket element is in engagement with a retaining lug of an introduced contact insert, and into an open position.

### CROSS-REFERENCE TO PRIOR APPLICATIONS

This application is a U.S. National Phase application under 35 U.S.C. § 371 of International Application No. PCT/EP2021/051799, filed on Jan. 27, 2021, and claims benefit to German Patent Application No. DE 10 2020 102 098.8, filed on Jan. 29, 2020. The International Application was published in German on Aug. 5, 2021 as WO/2021/151913 under PCT Article 21(2).

### FIELD

The invention relates to a retaining frame for a plug connector for receiving contact inserts. Furthermore, the invention relates to a plug connector having a housing, a retaining frame arranged in the housing, and a plurality of contact inserts received in the retaining frame. The invention further relates to an electronic device.

### BACKGROUND

Such retaining frames serve for the modular use of contact inserts, for example on plug connectors. One or more contact inserts can be arranged on such a retaining frame in order to be introduced together with the retaining frame into a housing of a plug connector part or of a plug connector and be connected to the housing. In this way, contact inserts can be combined with one another in a modular manner and arranged in or on a plug connector part via the retaining frame.

Such contact inserts can, for example, have one or more electrical contacts. In this event, the contact inserts are connected on the one hand to electrical lines which are supplied to a plug connector and on the other hand form plug contacts through which the plug connector can be brought into engagement with a mating plug connector part in a plug-in manner for electrical contact.

Such modular contact inserts offer the advantage of flexible combination capability and variable usability of plug connectors.

If contact inserts are attached to a retaining frame, it is necessary that the contact inserts be held on the retaining frame in order to enable an attachment of the retaining frame, for example to a plug connector, together with the contact inserts. Given a retaining frame known from DE 10 2012 110 907 A1, it is provided for this purpose that a second retaining frame part can be attached to a first retaining frame part, which first retaining frame has recesses for receiving retaining lugs of contact inserts, in order to in this way catch retaining lugs lying in the recesses and thus lock them on the retaining frame.

In a retaining frame known from DE 20 2012 103 360 U1, two different recesses are provided on frame walls. Retaining lugs of contact inserts can be introduced into first recesses on an upper edge of the frame walls so as to engage, whereas pin-like formations of the contact inserts can be brought into latching engagement with second recesses in the form of openings.

### SUMMARY

In an embodiment, the present invention provides a retaining frame for a plug connector for receiving contact inserts, comprising: a base frame having two opposing side walls and two opposing end walls, the two side walls and the two end walls enclosing an interior space of the base frame into which the contact inserts are introducible along an insertion direction, the side walls having a respective inner surface facing in a direction of the interior space and a respective outer surface directed away from the interior space; and securing means which, in a secured state, are configured to retain the contact inserts introduced into the interior space of the base frame on the base frame, the securing means respectively having a bracket element and an actuation lever, the bracket element being transferrable into a closed position in which the bracket element is in engagement with a retaining lug of an introduced contact insert, and into an open position in which the bracket element is out of engagement with the retaining lug of the introduced contact insert, the bracket element being braceable with the retaining lug by the actuation lever in the closed position.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIGS. 1 to 4 show a schematic representation of a retaining frame according to the invention during insertion and securing of a contact insert in the retaining frame,

FIG. 5 shows a schematic representation of a securing means shown in FIGS. 1 to 4,

FIG. 6 shows a schematic sectional representation of the position shown in FIG. 1,

FIG. 7 shows another schematic sectional representation of the position shown in FIG. 1, and

FIG. 8 shows a schematic sectional representation of the position shown in FIG. 4.

### DETAILED DESCRIPTION

In an embodiment, the present invention provides a retaining frame which enables a simple attachment of contact inserts to the retaining frame and a reliable locking of the contact inserts on the retaining frame, giving simultaneously easy removability of the contact inserts from the retaining frame.

The retaining frame according to the invention has a base frame which has two opposing side walls and two opposing end walls, wherein the two side walls and the two end walls enclose an interior space of the base frame into which the contact inserts can be introduced along an insertion direction, wherein the side walls have a respective inner surface facing in the direction of the interior space and a respective outer surface directed away from the interior space. The retaining frame furthermore has securing means which, in a secured state, retain the contact inserts introduced into the interior space of the base frame on the base frame, wherein the securing means have a respective bracket element and an actuation lever, wherein the bracket element can be transferred into a closed position in which the bracket element is engaged with a retaining lug of an introduced contact insert, and into an open position in which the bracket element is not engaged with the retaining lug of the introduced contact insert, wherein the bracket element can be braced with the retaining lug by means of the actuation lever in the closed position.

According to the invention, it is now provided to lock the contact inserts introduced into a retaining frame on the retaining frame by means of securing means which are respectively formed from a bracket element and an actuation lever. The securing means are thus formed at least in two parts. Each introduced contact insert can be retained on the retaining frame by means of two such securing means, in that the two securing means interact with the two retaining lugs arranged on a contact insert. The bracket element serves to interact directly with the contact insert, in that the bracket element interacts with one of the retaining lugs of a contact insert in the closed position. The actuation lever serves to brace the bracket element in this closed position or to brace it against the retaining lug associated with it. The bracket element can be braced by means of the actuation lever in order to be able to fix a retaining lug of a contact insert to the retaining frame, or to the base frame of the retaining frame. A particularly positionally secure fixing of the contact inserts to the retaining frame can hereby be achieved. The bracket element and the actuation lever are preferably in direct operative connection with one another. The securing means are preferably arranged on the side walls of the base frame so that the contact inserts can be secured to the side walls of the base frame. Via the respective securing means forming a lever closure via the bracket element and the actuation lever, each contact insert introduced into the retaining frame can be secured individually to the retaining frame. Via the respective securing means forming a lever closure, an optimally play-free securing of the contact inserts to the base frame can preferably take place. As viewed in the introduction direction, the actuation lever is preferably arranged below the bracket element. The securing means are preferably arranged on the outer surface of the side walls of the base frame. The securing means preferably do not extend along the inner surface of the side walls of the base frame.

The bracket element is preferably formed from a bent wire. The bracket element is preferably bent in such a way that this can surround the respective retaining lug, at least in regions, in the closed position. The bracket element designed in the form of a bent wire can have a U-shape, for example.

The bracket element is preferably designed in such a way that it rests in the closed position on an upper side of the retaining lug of the contact insert associated with it, said upper side being directed counter to the insertion direction. By resting the bracket element on the upper side of the retaining lug, the bracket element can exert a force in the insertion direction on the retaining lug, and thus on the contact insert, in order to fix the contact insert to the base frame. An optimally play-free fixing of the contact insert to the base frame is hereby possible. The bracket element preferably rests flat on the upper side of the retaining lug. The bracket element preferably has an elongated actuation segment which rests flat on the upper side of the retaining lug.

The bracket element can be pivotably mounted on the actuation lever. The bracket element can thus be pivoted relative to the actuation lever in order to be transferred from the closed position into the open position, and vice versa. For example, the actuation lever can have two bore holes in which a respective free end of the bracket element can be received. The bore holes can thus form an axis of rotation of the bracket element. Via the pivotable mounting of the bracket element on the actuation lever, the bracket element is preferably also positioned so as to be pivotable relative to the base frame or to the side wall of the base frame on which the bracket element is positioned.

The securing means are preferably secured to the base frame via the actuation levers of the securing means. Preferably, only the actuation lever is directly connected to the base frame, whereas the bracket element is secured to the base frame via the actuation lever so that the bracket element is secured only indirectly to the base frame. The actuation lever of each securing means can be pivotably mounted on the base frame, in particular on one of the two side walls of the base frame. Upon transferring the bracket element into the closed or into the braced position and into the open position, the actuation lever can thus also be pivoted relative to the base frame. Upon transferring into the closed or into the braced position and into the open position, both the bracket element and the actuation lever can thus be pivoted.

In order to form the pivotable mounting, the actuation lever can be connected to an axial body, wherein the axial body can be mounted in a cutout formed on one of the side walls of the base frame. The axial body can be rotatably mounted in the cutout. However, it is also possible that the axial body is arranged in a rotationally fixed manner in the cutout, and that the actuation lever is arranged rotatably on the axial body.

In order to be able to achieve a particularly secure securing of the contact inserts to the base frame by means of the securing means, an axis of rotation of the bracket element can be offset in relation to an axis of rotation of the actuation lever in the direction of the inner surface of the respective side wall, at least in the braced state. The axis of rotation of the bracket element is the axis about which the bracket element can be pivoted. The axis of rotation of the bracket element can be defined by the bore holes in the actuation lever, in which bore holes the bracket element can be mounted. The axis of rotation of the actuation lever is preferably defined by the axial body which is connected to the actuation lever and via which the actuation lever can be mounted on the base frame. Due to the inwardly offset arrangement of the axis of rotation of the bracket element in relation to the axis of rotation of the actuation lever, at least in the braced state of the bracket element via the actuation lever, it can be achieved that a dead center is exceeded upon closing the securing means or upon transferring the securing means into the secured state, whereby a defined end position of the securing means can be achieved and it can thereby be prevented that the lever closure formed by the securing means can open unintentionally or autonomously. The axis of rotation of the bracket element is preferably arranged below the axis of rotation of the actuation lever, as viewed in the insertion direction. Due to a pivoting movement of the actuation lever in order to brace the bracket element, the axis of rotation of the bracket element, said axis being formed in the region of the actuation lever, in particular in the region of the holes of the actuation lever, wanders and thus varies its position, whereas the axis of rotation of the actuation lever remains at a constant location in each position. In this way, the position of the axis of rotation of the bracket element relative to the position of the axis of rotation of the actuation lever can vary upon bracing the bracket element and also upon releasing the securing, and thus when releasing the bracing and transferring to the open position.

In the open position, both the bracket element and the actuation lever are preferably pivoted away from the base frame or from the respective side wall of the base frame so that, in the open position, the actuation lever and the bracket element extend at an angle to the plane spanned by the respective side wall of the base frame. In the open position, the bracket element preferably extends at an angle of α<180°, preferably at an angle between 110°≤α≤170°, with respect to the actuation lever. Via such a positioning of both the bracket element and the actuation lever, for a user it is immediately visually apparent in which state the securing means is found. The pivoting movement of the bracket element takes place both upon transferring into the closed or into the braced position and upon transferring into the open position, preferably in in the respective opposite direction. Upon transferring from the open position into the closed or into the braced position, the bracket element and the actuation lever are preferably pivoted away from one another. Upon transferring from the closed or braced position into the open position, the bracket element and the actuation lever are preferably pivoted toward one another.

In order to achieve a defined and correct positioning of the actuation lever, in particular in the braced state, a respective plurality of recesses can be formed on the outer surface of the side walls, in which recesses a respective actuation lever of one of the securing means can be received in the braced state. The contour of the recesses can be adapted to the outer contour of the actuation levers. By receiving the actuation levers in a respective recess, the actuation lever can be prevented from protruding from the outer surface of the side wall in the closed position. In particular, a flush or at least an almost flush arrangement of the actuation lever with the outer surface of the respective side wall can be achieved.

In order to be able to achieve a defined and correct positioning of the bracket element, in particular in the closed position or in the braced state, a plurality of groove-shaped cutouts can respectively be formed on the outer surface of the side walls, into which cutouts a respective one of the bracket elements of one of the securing means can be introduced in the closed position or in the braced state. In its closed position or in the braced state, the bracket element can thereby be prevented from protruding from the outer surface of the side wall, so that an undesired opening of the securing means can also be prevented directly via the bracket element. The groove-shaped cutouts are preferably adapted in their shape to the shape of the bracket element. Via the groove-shaped cutouts, a flush or at least an almost flush arrangement of the bracket element with the outer surface of the respective side wall can be achieved.

The base frame can have support surfaces for supporting the retaining lugs, which are formed on an upper edge of the base frame facing counter to the insertion direction. The retaining lugs can thus rest directly on the base frame in the state in which they are secured to the base frame. The retaining lugs can be pushed against the support surface by means of the securing means, in particular by means of the bracket element of the securing means, in order to enable a secure and play-free securing of the contact inserts to the base frame. The support surfaces can be formed in openings formed on the side walls of the base frame. The support surfaces can respectively form a bottom wall of the openings. The upper edge formed circumferentially on the base frame can run in different planes through the openings.

The achievement of the object according to the invention additionally takes place by means of a method for installing at least one contact insert on a retaining frame designed and developed as described above, in which the at least one contact insert is introduced along the insertion direction into the interior space of the base frame of the retaining frame, and the bracket element of the securing means of the retaining frame is subsequently manually transferred from the open position into the closed position in order to engage the bracket element with the retaining lug of the introduced contact insert, and wherein, in the closed position, the bracket element is subsequently transferred by means of the actuation lever into a state in which it is braced with the retaining lug of the introduced contact insert.

By manually actuating the bracket element of the securing means, that is to say via the actuation of the bracket element of the securing means by a user's hand, it is possible that the contact inserts can be secured or latched to the retaining frame independently of their insertion movement. This means that, in a first step, the contact insert is introduced into the retaining frame and, in a second step, the contact insert is latched to the retaining frame, wherein the insertion and the latching, and thus the first step and the second step, can take place with a temporal offset. For example, all contact inserts can thereby first be introduced into the retaining frame, and only when all contact inserts are introduced does a latching of the contact inserts to the retaining frame take place by means of manually actuation of the bracket elements of the individual securing means. An automatic latching of the contact inserts at the end of the insertion process into the retaining frame is thus not present.

In an embodiment, the present invention provides a plug connector which has a housing, a retaining frame arranged in the housing, and a plurality of contact inserts received in the retaining frame, wherein the retaining frame is designed and developed as described above.

In an embodiment, the present invention provides an electronic device which has at least one retaining frame designed and developed as described above, and a plurality of contact inserts received in the retaining frame, and/or at least one plug connector designed and developed as described above.

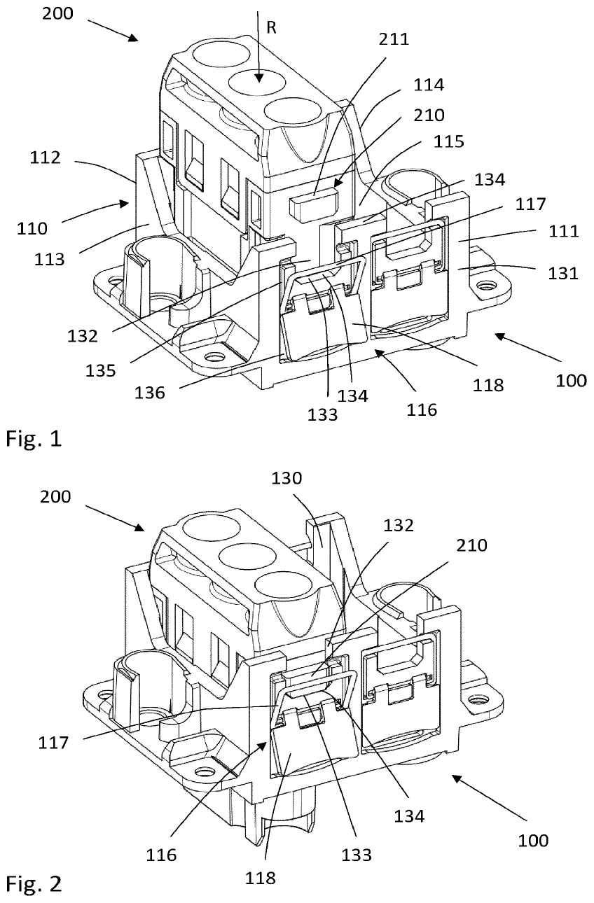

FIGS. 1 to 4 show a retaining frame 100 upon introduction of contact insert 200 into the retaining frame 100.

The retaining frame 100 has a base frame 110 which has two opposing side walls 111, 112 and two opposing end walls 113, 114. The side walls 111, 112 are arranged at a right angle to the end walls 113, 114. The base frame 110 has an interior space 115 which is delimited or enclosed by the two side walls 111, 112 and the two end walls 113, 114. The contact inserts 200 are introduced into this interior space 115 in that the contact inserts 200 are introduced in the insertion direction R into the base frame 110, and thus into the interior space 115 of the base frame 110.

In order to secure the contact inserts 200 introduced into the base frame 110 to said base frame 110, the retaining frame 100 has a plurality of securing means 116 which are arranged on the base frame 110, in particular on the side walls 111, 112 of the base frame 110. Two securing means 116 are provided for each contact insert 200, wherein retaining lugs 210 formed on the contact inserts 200 can be clamped by means of the securing means 116 to the base frame 110, in particular to the side walls 111, 112 of the base frame 110, in order to fix the contact inserts 200 to the base frame 110.

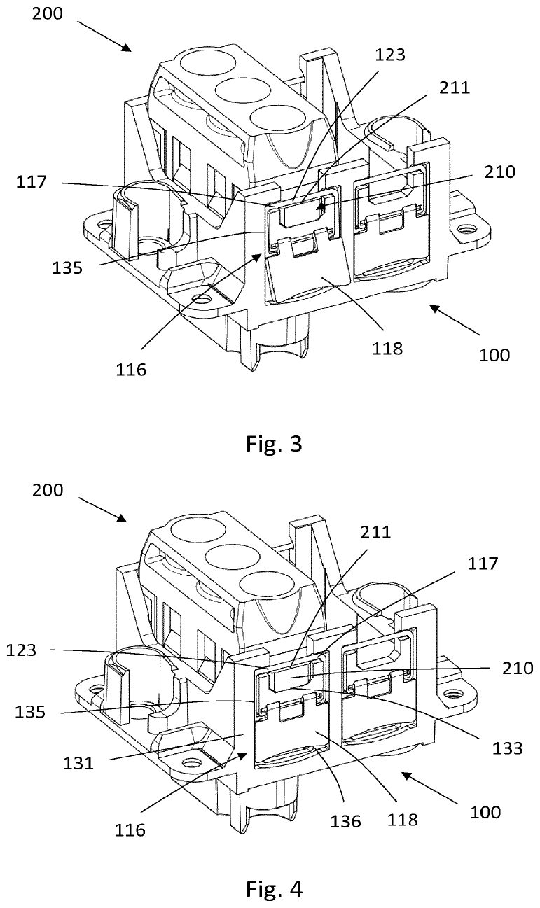

FIG. 5 shows such a securing means 116 by itself. The securing means 116 has a bracket element 117 and an actuation lever 118. The bracket element 117 and the actuation lever 118 are directly connected to one another. The bracket element 117 can be transferred into an open position, as shown in particular in FIG. 1, and into a closed position, as shown in particular in FIGS. 3 and 4. In the closed position, the bracket element 117 can be braced by means of the actuation lever 118 and, in particular, be braced against the retaining lug 210 of the introduced contact insert 200.

The actuation lever 118 is arranged below the bracket element 117 as viewed in the insertion direction R. In the embodiment shown here, the actuation lever 118 and the bracket element 117 have approximately the same width.

The bracket element 117 is formed from a bent wire. The bracket element 117 has substantially a U-shape. The bracket element 117 has two free ends 119, 120, via which the bracket element 117 is secured, in particular rotatably or pivotably secured, to the actuation lever 118. Two bore holes 121, 122, into which the free ends 119, 120 of the bracket element 117 engage, are formed on the actuation lever 118. The two free ends 119, 120 are bent in such a way that they face toward one another.

The bracket element 117 has an actuation segment 123 which can interact directly with one of the retaining lugs 210 of a contact insert 200. In the closed position of the bracket element 117, the bracket element 117 can rest with the actuation segment 123 on the retaining lug 210 of the contact insert 200, and in the braced state, the actuation segment 123 is braced against the retaining lug 210. The actuation segment 123 is arranged at a distance from the actuation lever 118. A free space 124 is formed between the actuation segment 123 and the actuation lever 118, through which free space the retaining lug 210 to be fixed can dip.

The bracket element 117 is pivotably mounted on the actuation lever 118. The axis of rotation DBE of the bracket element 117 runs through the free ends 119, 120 and through the holes 121, 122. The actuation segment 123 extends parallel to the axis of rotation DBE of the bracket element 117.

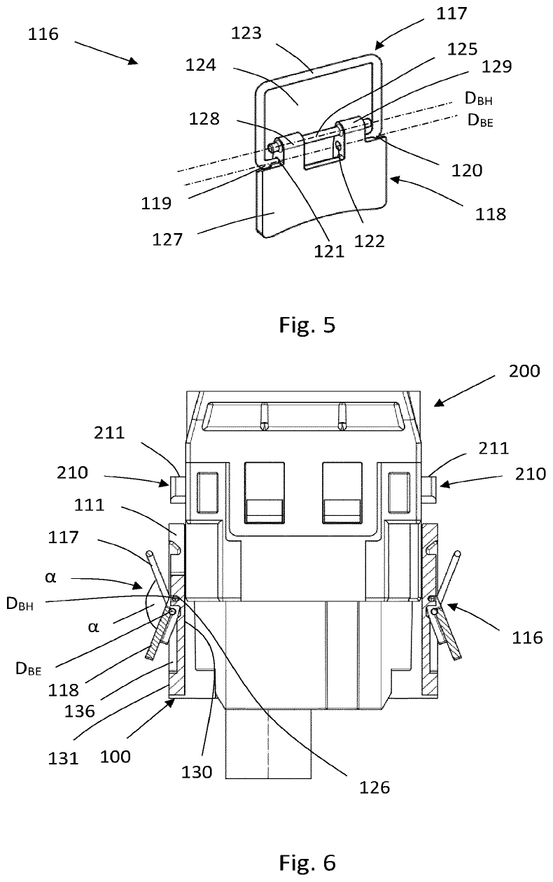

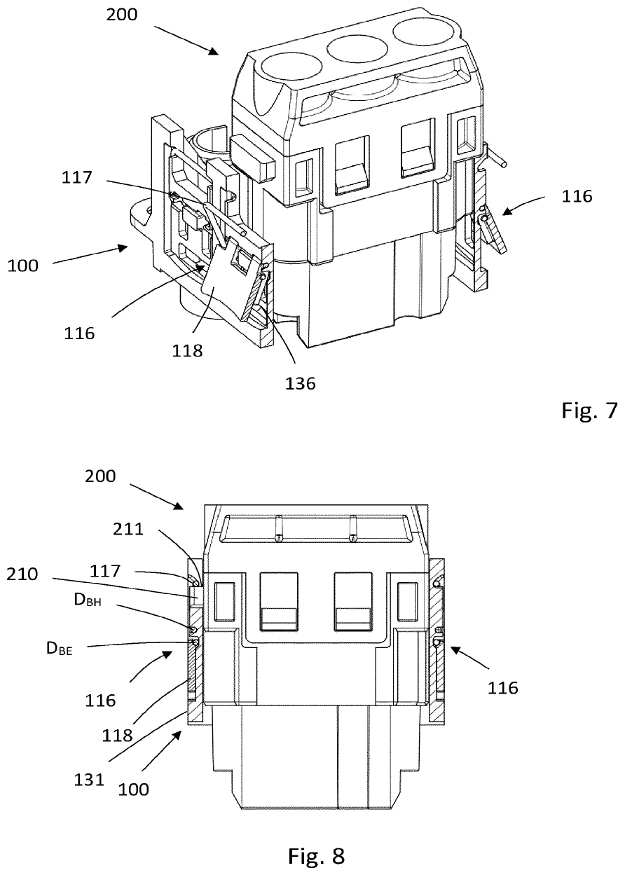

The actuation lever 118 is mounted on the base frame 110 so as to be pivotable about an axial body 125. The axial body 125 is mounted in a cutout 126 formed on one of the side walls 111, 112 of the base frame 110, as is apparent in particular in the sectional representation in FIG. 6.

The actuation lever 118 has a substantially rectangular base body 127. Two securing pins 128, 129 are integrally formed on this base body 127. The axial body 125 is mounted on these two securing pins 128, 129. The securing pins 128, 129 extend from the base body 127 in the direction of the bracket element 117, in particular in the direction of the actuation segment 123 of the bracket element 117. The two securing pins 128, 129 run parallel to one another. The two securing pins 128, 129 respectively have a bore hole through which the axial body 125 is guided. The bore hole holes of the securing pins 128, 129 are arranged in alignment with one another.

The axis of rotation DBH of the actuation lever 118 extends along the longitudinal axis of the axial body 125. The axis of rotation DBH of the actuation lever 118 runs parallel to the axis of rotation DBE of the bracket element 117. As viewed in the insertion direction R, the axis of rotation DBH of the actuation lever 118 is arranged above the axis of rotation DBE of the bracket element 117.

The side walls 111, 112 of the base frame 110 have an inner surface 130 directed in the direction of the interior space 115, and an outer surface 131 facing away from the interior space 115. Here, the securing means 116 are arranged exclusively on the outer surface 131 of the side walls 111, 112.

Upon introduction of a contact insert 200 into the retaining frame 100, the bracket element 117 is initially located in an open position, as shown in FIG. 1. The bracket element 117 is hereby pivoted away from the outer surface 131. The actuation lever 118 is also pivoted away from the outer surface 131. The bracket element 117 and the actuation lever 118 here extend at an angle α of approximately 160° relative to one another, as shown in FIG. 6. Both the bracket element 117 and the actuation lever 118 are here pivoted out of the plane of the respective side wall 111, 112.

In that the bracket element 117 is pivoted away from the outer surface 131, the contact insert 200 can be introduced with its retaining lug 210 into an opening 132 formed on the base frame 110, in particular on the side wall 111, 112 of the base frame 110. The opening 132 is U-shaped. A bottom wall of the opening 132 forms a support surface 133 for the introduced retaining lug 210. The contact insert 200 is introduced far enough into the interior space 115 of the base frame 110 until the retaining lug 210 of the contact insert 200 comes to rest on the support surface 133, as is apparent in FIG. 2.

The width of the opening 132 corresponds substantially to the width of the retaining lug 210. The support surface 133 is formed on an upper edge 134 of the base frame 110 facing counter to the insertion direction R. In the region of the openings 132, the upper edge 134 is arranged offset downward in the insertion direction R.

If the retaining lug 210 rests on the support surface 133, the bracket element 117 is initially pivoted in the direction of the outer surface 131, whereby the bracket element 117 is pivoted about the retaining lug 210 of the contact insert 200, said retaining lug 210 being arranged in the opening 132. The bracket element 117 with its actuation segment 123 is thereby engaged with the retaining lug 210, in that the actuation segment 123 comes to rest on an upper side 211 of the retaining lug 210 facing counter to the insertion direction R, as shown in FIG. 3. The bracket element 117 can thus push the retaining lug 210 against the base frame 110, in particular against the support surface 133 of the side wall 111, 112 of the base frame 110. Via the actuation segment 123, the bracket element 117 can exert a compressive force acting in the insertion direction E on the retaining lug 210. In this position, the bracket element 117 is arranged in a plane with the side wall 111, 112 of the base frame 110. The retaining lug 210 is located here in the free space 124 between the actuation segment 123 and the actuation lever 118.

For each bracket element 117, a groove-shaped cutout 135 is formed on the outer surface 131 of the side walls 111, 112, into which cutout the bracket element 117 can dip in the closed position, as shown for example in FIGS. 3 and 4, so that the bracket element 117 does not protrude from the outer surface 131 in the closed position.

Subsequently, the bracket element 117 is still braced against the retaining lug 210 of the contact insert 200 in order to be able to achieve an optimally play-free fixing of the contact insert 200 to the retaining frame 100.

For this purpose, the actuation lever 118, as shown in FIG. 4, is pivoted in the direction of the outer surface 131 of the side wall 111, 112 until the actuation lever 118 also extends in the plane of the side wall 111, 112. Via this pivoting movement of the actuation lever 118, the actuation segment 123 is pulled, in the insertion direction R, even closer to the upper side 211 of the retaining lug 210. In this secured and braced state, as shown in FIG. 4, the actuation lever 118 and the bracket element 117 extend at an angle α of 180° relative to one another, so that the actuation lever 118 and the bracket element 117 extend in one plane.

For each actuation lever 118, a recess 136 is formed on the outer surface 131 of the side wall 111, 112, in which recess the actuation lever 118 is received in this braced state so that the actuation lever 118 does not protrude from the outer surface 131.

As can be seen in the sectional representation of FIG. 8, in the secured state, as is also shown in FIG. 4, the axis of rotation DBE of the bracket element 117 is offset in relation to the axis of rotation DBH of the actuation lever 118 in the direction of the interior space 115, or in the direction of the inner surface 130 of the side walls 111, 112. Upon closing the actuation lever 118, due to the pivoting movement of the actuation lever 118 the axis of rotation DBE of the bracket element 117 wanders in the direction of the inner surface 130, whereby the position of the axis of rotation DBE of the bracket element 117 varies relative to the position of the axis of rotation DBH of the actuation lever 118, as is apparent in particular in a comparison of FIG. 6 with FIG. 8. It can hereby be achieved that, upon closing the securing means 116, a dead center is exceeded that prevents the bracket closure formed by the securing means 116 from being unintentionally opened.

In order to open the securing means 116, the actuation lever 118 is initially pivoted away from the outer surface 131 again. Via this pivoting movement, the bracket element 117 is also displaced away from the outer surface 131 in a pivoting movement so that the bracket element 117 follows the pivoting movement of the actuation lever 118. The retaining lug 210 is thereby released so that the contact insert 200 can again be pulled out of the interior space 115 of the base frame 110, counter to the insertion direction R.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 Retaining frame
110 Base frame
111 Side wall
112 Side wall
113 End wall
114 End wall
115 Interior space
116 Securing means
117 Bracket element
118 Actuation lever
119 Free end
120 Free end
121 Bore hole
122 Bore hole
123 Actuation segment
124 Free space
125 Axial body
126 Cutout
127 Base body
128 Fastening pin
129 Fastening pin
130 Inner surface
131 Outer surface
132 Opening
133 Support surface
134 Upper edge
135 Groove-shaped cutout
136 Recess
200 Contact insert
210 Retaining lug
211 Upper side
R Insertion direction
DBE Axis of rotation of the bracket element
DBH Axis of rotation of the actuation lever

1. A retaining frame for a plug connector for receiving contact inserts, comprising:
a base frame having two opposing side walls and two opposing end walls, the two side walls and the two end walls enclosing an interior space of the base frame into which the contact inserts are introducible along an insertion direction, the side walls having a respective inner surface facing in a direction of the interior space and a respective outer surface directed away from the interior space; and
securing means which, in a secured state, are configured to retain the contact inserts introduced into the interior space of the base frame on the base frame, the securing means respectively having a bracket element and an actuation lever, the bracket element being transferrable into a closed position in which the bracket element is in engagement with a retaining lug of an introduced contact insert, and into an open position in which the bracket element is out of engagement with the retaining lug of the introduced contact insert, the bracket element being braceable with the retaining lug by the actuation lever in the closed position.

2. The retaining frame of claim 1, wherein the bracket element comprises a bent wire.

3. The retaining frame of claim 1, wherein the bracket element is configured such that, in the closed position, the bracket element rests on an upper side of the retaining lug of the contact insert associated with the bracket element, the upper side being directed counter to the insertion direction.

4. The retaining frame of claim 1, wherein the bracket element is pivotably mounted on the actuation lever.

5. The retaining frame of claim 1, wherein the actuation lever is pivotably mounted on the base frame.

6. The retaining frame of claim 5, wherein the actuation lever is connected to an axial body, and
wherein the axial body is mounted in a cutout formed on one side wall of the two side walls of the base frame.

7. The retaining frame of claim 5, wherein an axis of rotation of the bracket element is offset in relation to an axis of rotation of the actuation lever in a direction of the inner surface of the respective side wall, at least in the secured state.

8. The retaining frame claim 1, wherein, in the open position, the bracket element extends at an angle α<180° relative to the actuation lever.

9. The retaining frame of claim 1, wherein a plurality of recesses are respectively formed on the outer surface of the side walls, in which recesses an actuation lever of one of the securing means is respectively received in the secured state.

10. The retaining frame of claim 1, wherein a plurality of groove-shaped cutouts are respectively formed on the outer surface of the side walls, into which cutouts the respective bracket element of one of the securing means dips in the closed position.

11. The retaining frame of claim 1, wherein the base frame has support surfaces configured to support the retaining lugs of the contact inserts introduced into the interior space, and
wherein the support surfaces are formed on an upper edge of the base frame the upper edge facing counter to the insertion direction.

12. A method for installing at least one contact insert on the retaining frame of claim 1, comprising:
introducing the at least one contact insert along the insertion direction into the interior space of the base frame of the retaining frame;
subsequently manually transferring the bracket element of the securing means of the retaining frame from the open position into the closed position in order to engage the bracket element with the retaining lug of the introduced contact insert; and
in the closed position, subsequently transferring the bracket element is by the actuation lever into a state in which it is secured with the retaining lug of the introduced contact insert.

13. A plug connector, comprising:
a housing;
the retaining frame of claim arranged in the housing; and
a plurality of contact inserts received in the retaining frame.

14. An electronic device, comprising:
at least one retaining frame of claim 1; and
a plurality of contact inserts received in the retaining frame.

15. The retaining frame claim 8, wherein the angle α is 110°≤α≤170°.

16. An electronic device, comprising:
at least one plug connector of claim 13.
